(19) United States
(12) Patent Application Publication
(10) Pub. No.: US 2010/0332653 A1
(43) Pub. Date: Dec. 30, 2010

(54) IMAGE FORMING APPARATUS AND IMAGE FORMING METHOD

(75) Inventor: Takayuki Mizuno, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/823,271

(22) Filed: Jun. 25, 2010

Related U.S. Application Data
(60) Provisional application No. 61/221,346, filed on Jun. 29, 2009.

(51) Int. Cl. G06F 15/173; G06F 21/20

(52) U.S. Cl. 709/224; 726/4

(57) ABSTRACT

According to one embodiment, an image forming apparatus includes a unit configured to transmit input authentication information of a user or a department to a server apparatus, a unit configured to acquire setting information input, concerning a job allocated to the authenticated user or department, a unit configured to transmit the setting information to the server apparatus and request the sever apparatus to permit printing, a unit configured to receive a provisional limited number of printed sheets from the server apparatus and execute printing, a unit configured to request transmission of a new provisional limited number of printed sheets, a unit configured to receive the new provisional limited number of printed sheets from the server apparatus and execute the printing, and a unit configured to transmit the number of printed sheets to the server apparatus in a predetermined case.

### CROSS-REFERENCE TO RELATED APPLICATIONS

This application is based upon and claims the benefit of U.S. Provisional Application No. 61/221,346 filed on Jun. 29, 2009; the entire contents of each of which are incorporated herein by reference.

### FIELD

Embodiments described herein relate generally to an image forming apparatus such as an MFP (Multi-Function Peripheral), an image forming system in which the image forming apparatus such as the MFP and a server are connected via a network, and a method of controlling the image forming apparatus.

### BACKGROUND

As a form of an image forming apparatus, there is an apparatus called MFP (Multi-Function Peripheral). The MFP is a digital complex machine configured to realize plural functions such as a scanner function, a facsimile function, and an image data storing function in addition to a copying function. One MFP plays roles of plural apparatuses.

Among MFPs, conventionally, there is an MFP having a management function called a role management function. The role management function is a function of limiting plural functions, i.e., plural roles of the MFP according to a user or a department of the MFP.

For example, it is assumed that the MFP has a role (a) of a copying machine, a role (b) of a scanner, a role (c) of a facsimile apparatus, and a role (d) of an image data storing apparatus. The MFP allows a user A to use the roles (a) and (c) and prohibits the user A from using the roles (b) and (d). On the other hand, the MFP allows a user B to use the roles (a), (b), and (d) and prohibits the user B from using the role (c). Such a management function is called role management function.

Various forms are known as a form for executing the role management function for each of departments and each of users. For example, the role management function is executed not only in the MFP but also in an external server connected to the MFP. Further, a form in which the external server is connected to plural MFPs is also disclosed. When management of the users and the departments is performed by using the external server in this way, there is a need for preventing management from becoming complicated. Further, when the plural MFPs are used, there is a need for realizing unification of management information.

### BRIEF DESCRIPTION OF THE DRAWINGS

FIG. 1 is an exemplary view showing a diagram of a configuration of an image forming system and an image forming apparatus according to an embodiment;

FIG. 2 is an exemplary view showing a schematic diagram of a relation between users who use the image forming system or the image forming apparatus and departments to which the users belong according to an embodiment;

FIG. 3 is an exemplary view showing a table of the structure of an authentication database according to an embodiment;

FIG. 4 is an exemplary view showing a table of the structure of a role management database according to an embodiment;

FIG. 5 is an exemplary view showing a diagram of classified items for which limited numbers of times are controlled by a server according to an embodiment;

FIG. 6 is an exemplary view showing a diagram of the structure of limitation database according to an embodiment;

FIG. 7 is an exemplary view showing a flowchart for explaining an operation procedure of the image forming system according to an embodiment;

FIG. 8 is an exemplary view showing a diagram of an authentication screen according to an embodiment;

FIG. 9 is an exemplary view showing a flowchart for explaining a processing procedure for calculating a provisional limited number of printed sheets in the server according to an embodiment;

FIG. 10 is an exemplary view showing a flowchart for explaining a processing procedure for calculating an additional provisional limited number of printed sheets in the server according to an embodiment; and

FIG. 11 is an exemplary view showing a flowchart for explaining a processing procedure for ending printing limitation control in the server according to an embodiment.

### DETAILED DESCRIPTION

In general, according to one embodiment, an image forming apparatus includes a unit configured to transmit input authentication information of a user or a department to a server apparatus, a unit configured to acquire setting information input concerning a job allocated to the authenticated user or department, a unit configured to transmit the setting information to the server apparatus and request the sever apparatus to permit printing, a unit configured to receive a provisional limited number of printed sheets from the server apparatus and execute printing, a unit configured to request transmission of a new provisional limited number of printed sheets, a unit configured to receive the new provisional limited number of printed sheets from the server apparatus and execute the printing, and a unit configured to transmit the number of printed sheets to the server apparatus in a predetermined case.

An image forming system and a method of controlling the image forming system according to an embodiment of the present invention are explained below with reference to the accompanying drawings.

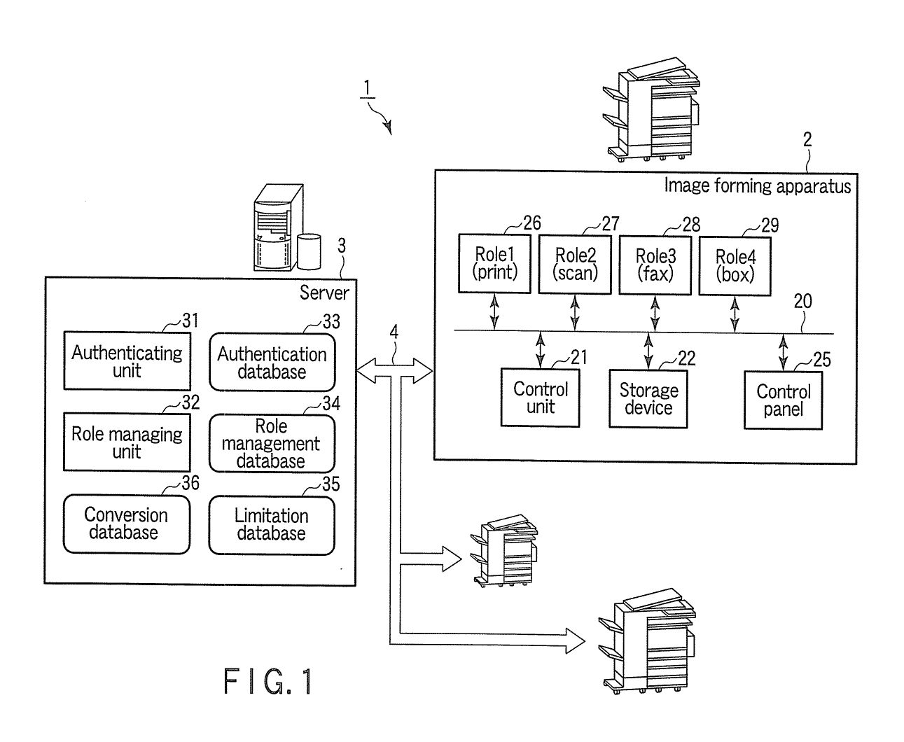

FIG. 1 is an exemplary view showing a diagram of a configuration of an image forming system and an image forming apparatus according to an embodiment. The image forming system 1 includes at least one image forming apparatus 2 and a server 3, which are connected via a network 4.

The image forming apparatus 2 is a digital complex machine called MFP. One image forming apparatus 2 can play roles of plural apparatuses such as a copying machine, a scanner, a facsimile apparatus, and an image data recording apparatus (a BOX apparatus).

In some image data storing device included in the image forming apparatus 2, a recording areas thereof is divided into plural recording areas called boxes (e.g., n boxes from a box 1 to a box n). In this case, the role (d) of an image data storing function explained in the background can be subdivided into roles (d1) to (dn) for respectively using the boxes 1 to n. The role management function is more finely performed.

In FIG. 1, as an example of the roles of the plural apparatuses, the role of the copying machine is represented as role (1) 26, the role of the scanner is represented as role (2) 27, the role of the facsimile apparatus is represented as role (3) 28, and the role of the BOX apparatus is represented as role (4) 29.

The image forming apparatus 2 includes a control unit 21, a storage device 22, and a control panel 25. The control panel 25 captures instructions for setting and execution of various functions input by a user and displays and notifies necessary information to the user. The storage device 22 is a recording medium such as a HDD set in the inside of the image forming apparatus 2. An image file, various kinds of setting information, and the like are stored in the storage device 22. The control unit 21 controls the units connected thereto via a system bus 20.

The server 3 includes an authenticating unit 31, a role managing unit 32, an authentication database 33, a role management database 34, and a limitation database 35.

The authentication information is input from the control panel 25 by the user. The authenticating unit 31 performs user authentication by determining whether authentication information transmitted from the image forming apparatus 2 and authentication information registered in the authentication database 33 coincide with each other.

The role managing unit 32 executes role management on the basis of data registered in the role management database 34. Roles allocated to each of users and departments are registered in the role management database 34 in advance. The role managing unit 32 permits the user or the department to use only the allocated roles. The role managing unit 32 manages and controls the operation of the image forming apparatus 2 on the basis of the limitation database 35.

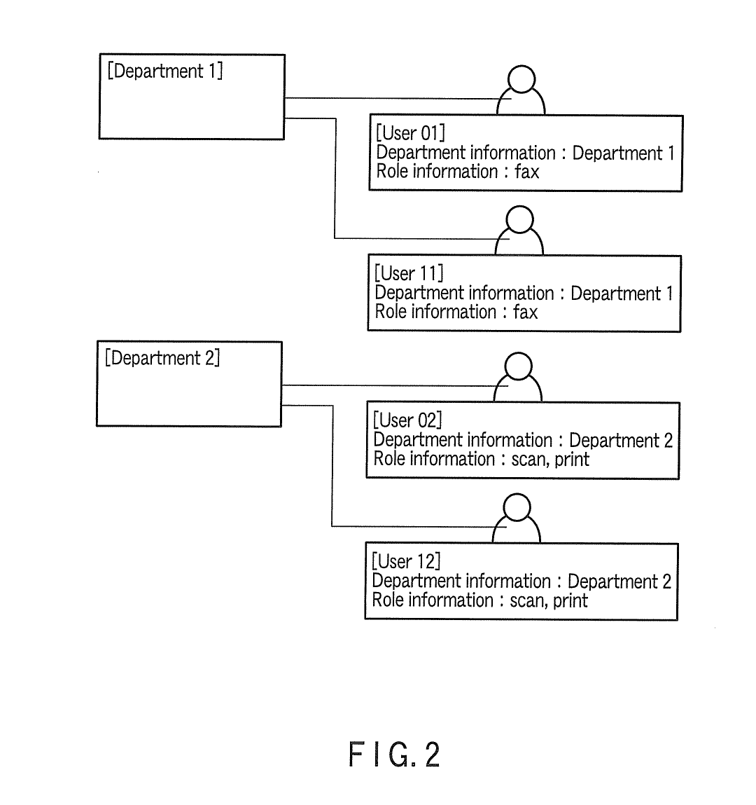

FIG. 2 is an exemplary view showing a schematic diagram of a relation between users who use the image forming system or the image forming apparatus and departments to which the users belong according to an embodiment. The users mean individual users. For example, a “user 01”, a “user 11”, and the like belong to a “department 1”. A “user 02”, a “user 12”, and the like belong to a “department 2”.

The role managing unit 32 in this embodiment has a function of collectively performing role management not only in user unit but also in department unit.

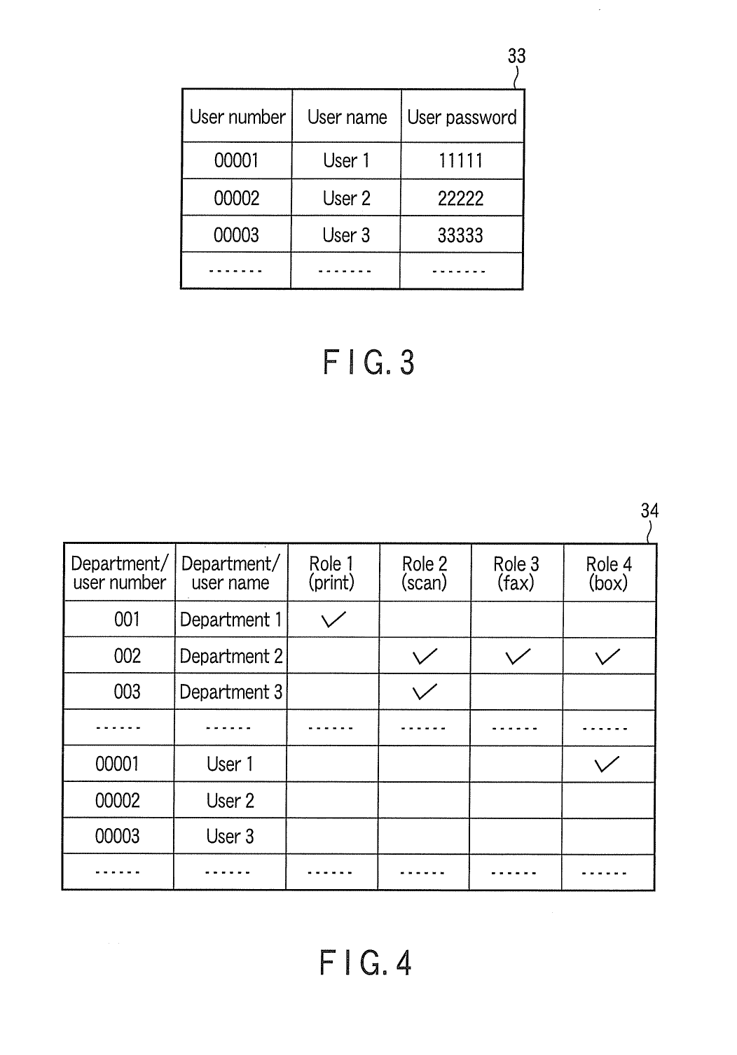

FIG. 3 is an exemplary view showing a table of the structure of an authentication database according to an embodiment. The authentication database 33 is a database exclusively used for user authentication. In the authentication database 33, association between users represented by “user number” and “user name” and “user password” as authentication information is registered.

FIG. 4 is an exemplary view showing a table of the structure of a role management database according to an embodiment. The role management database 34 is a database exclusively used for role management. In the role management database 34, a data region indicating allocation of roles in department unit and a data region indicating allocation of roles in user unit are provided. Check marks in the table indicate that roles are allocated. Blanks indicate that roles are not allocated.

In the data region in department unit, association between departments represented by “department number” and “department name” and roles allocated to the departments is registered. In the example shown in FIG. 4, the role (1) is allocated to a “department 1”, the roles (2), (3), and (4) are allocated to a “department 2”, the role (2) is allocated to a “department 3”.

In the data region in user unit, association between users represented by “user number” and “user name” and roles allocated to the users is registered. In the example shown in FIG. 4, only the role (4) is allocated to a “user 1” and the roles (1), (2), and (3) are not allocated to the “user 1”. No role is allocated to a “user 2” and a “user 3”.

The database 33 for user authentication and the database 34 for role management do not always need to be provided independently from each other and may be configured as an integral database obtained by combining both the databases. The role management database 34 is not limited to the form shown in FIG. 4. A database indicating allocation of roles in department unit and a database indicating allocation of roles in user unit may be independently provided.

A method of limiting the operation of the image forming apparatus 2 using the server 3 is explained below. The number of times is limited for each operation of the image forming apparatus 2 in advance in association with a user or a department. The server 3 controls all the image forming apparatuses 2 connected thereto not to operate exceeding a limited number of times.

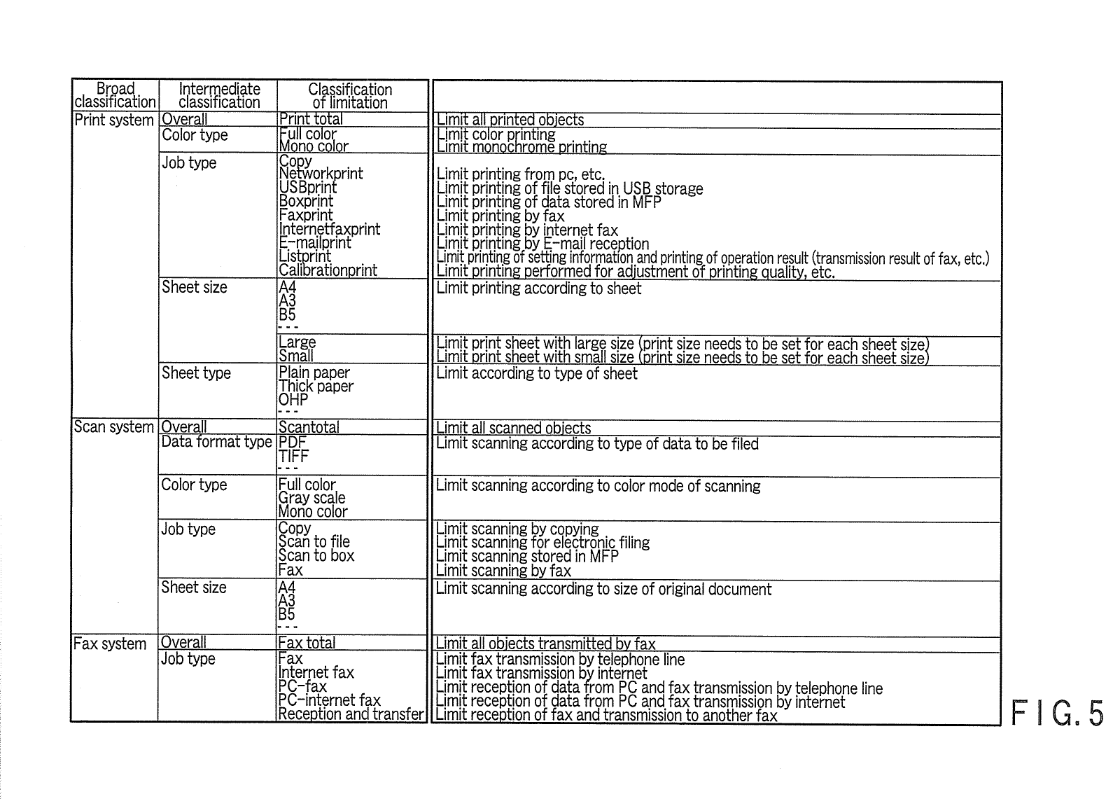

FIG. 5 is an exemplary view showing a diagram of classified items for which limited numbers of times are controlled by a server according to an embodiment. Items are broadly classified according to roles of “print system”, “scan system”, and “facsimile system” and intermediately classified into types such as “color type” and “job type” for each of the roles.

Limitation content of the “print system” is explained. In an intermediate classification “overall”, the number of printed sheets can be limited not to exceed a reference value irrespectively of a type. In “color type”, the number of printed sheets in color printing and the number of printed sheets in monochrome printing can be respectively limited not to exceed reference values. In “job type”, the numbers of printed sheets in print jobs such as copying, network printing, and USB printing can be respectively limited not to exceed reference values. In “sheet size”, the number of printed sheets in sizes of sheets such as “A4” and “B5” can be respectively limited not to exceed reference values. In “sheet type”, the number of printed sheets in types of sheets such as “plain paper” and “OHP” can be respectively limited not to exceed reference values.

In this embodiment, a printing function of the image forming apparatus 2 is explained. Therefore, the limited “number of times” is explained as a limited “number of sheets”. However, in other embodiments, the limited number of times is not limited to the limited number of sheets and can be treated as the limited number of times.

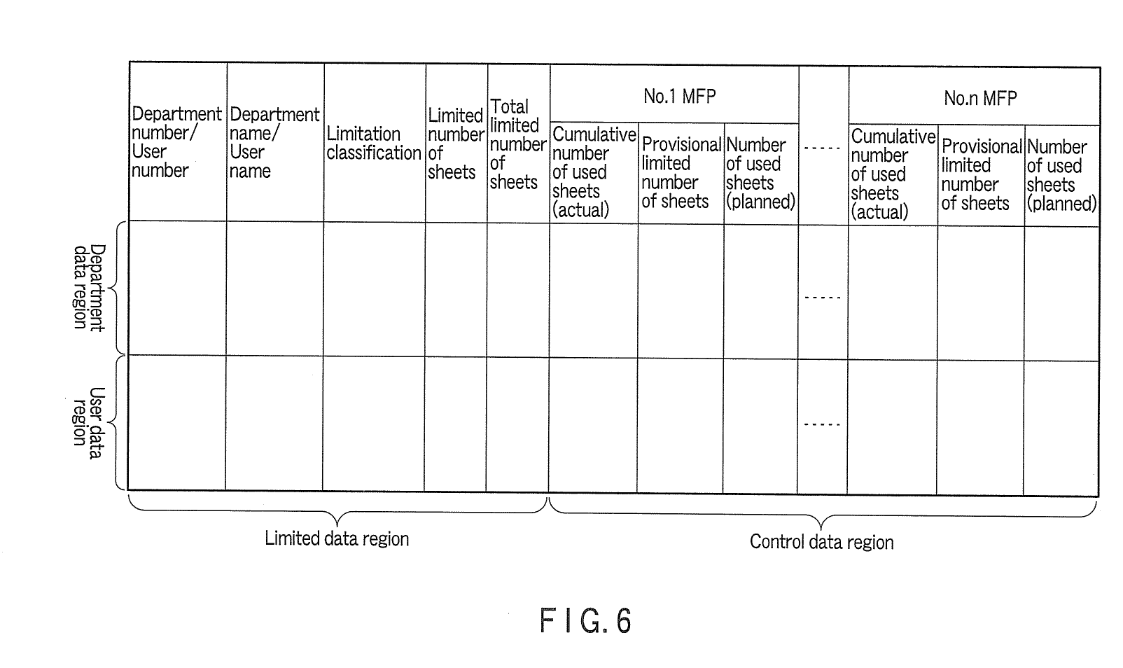

FIG. 6 is an exemplary view showing a diagram of the structure of limitation database according to an embodiment. The limitation database 35 is a database used for controlling a limited number of sheets of the image forming apparatus 2. In the limitation database 35, a department data region for controlling a limited number of sheets in department unit and a user data region for controlling a limited number of sheets in user unit are provided.

In the limitation database 35, “limitation classification”, “limited number of sheets”, and “total limited number of sheets” are registered as references for controlling a limited number of sheets. The “limitation classification” corresponds to “broad classification”, “intermediate classification”, and “classification of limitation” of the items shown in FIG. 5. The “limited number of sheets” represents a reference value for each of items shown in the “limitation classification”. The operation of the image forming apparatus 2 is limited not to exceed the reference value.

The “total limited number of sheets” specifies a limited number of sheets under standard conditions. For example, when the standard conditions are “monochrome printing”, “sheet size A4”, and “plain paper”, if printing of one sheet is performed under the conditions, the printed sheet is counted as one. However, if printing of one sheet is performed in “color printing”, two sheets are calculated as being printed under the standard conditions. If one sheet is printed in “sheet size A3”, two sheets are calculated as being printed under the standard conditions. If one sheet is printed in “thick paper”, two sheets are calculated as being printed under the standard conditions. It is possible to convert the limited number of sheets in the image forming apparatus 2 into a limited number of sheets under the standard conditions referring to a conversion database 36.

The “total limited number of sheets” is a reference value for each of departments or each of users in a predetermined period. The predetermined period can be set for each of the users or departments to, for example, one day, one month, half year, one year, or the like.

In the limitation database 35, “cumulative number of used sheets (actual)”, “provisional limited number of sheets”, and “number of used sheets (planned)” are registered for each of image forming apparatuses as parameters for controlling the limited number of sheets. The “cumulative number of used sheets (actual)” is a cumulative number of used sheets under the standard conditions. The “cumulative number of used sheets (actual)” is reset after elapse of the predetermined period. The number of sheets is counted anew. The “provisional limited number of sheets” is a limited number of sheets provisionally instructed to the image forming apparatus 2 by the server 3. Details of the “provisional limited number of sheets” are explained later. The “number of used sheets (planned)” is a temporary parameter value used when the server 3 carries out limitation control. Details of the “number of used sheets (planned)” are explained later.

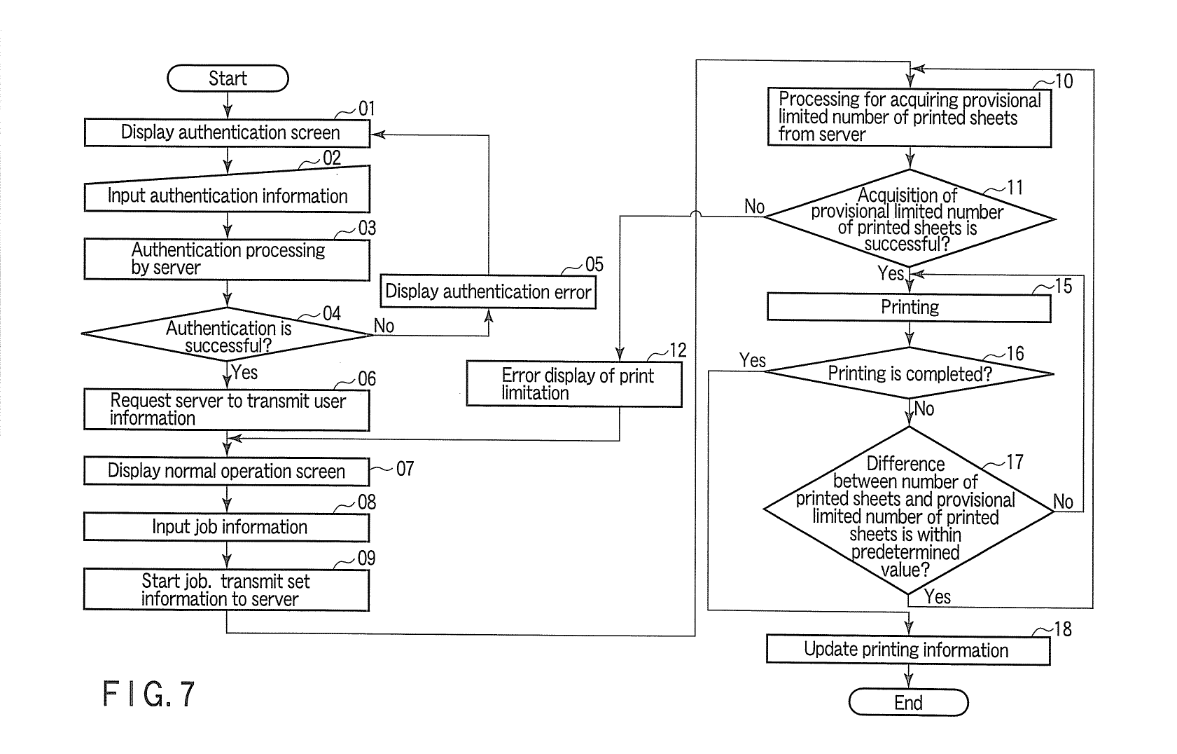

The operation of the image forming system according to this embodiment is explained below. In this embodiment, printing is executed in the image forming apparatus 2. FIG. 7 is an exemplary view showing a flowchart for explaining an operation procedure of the image forming system according to an embodiment.

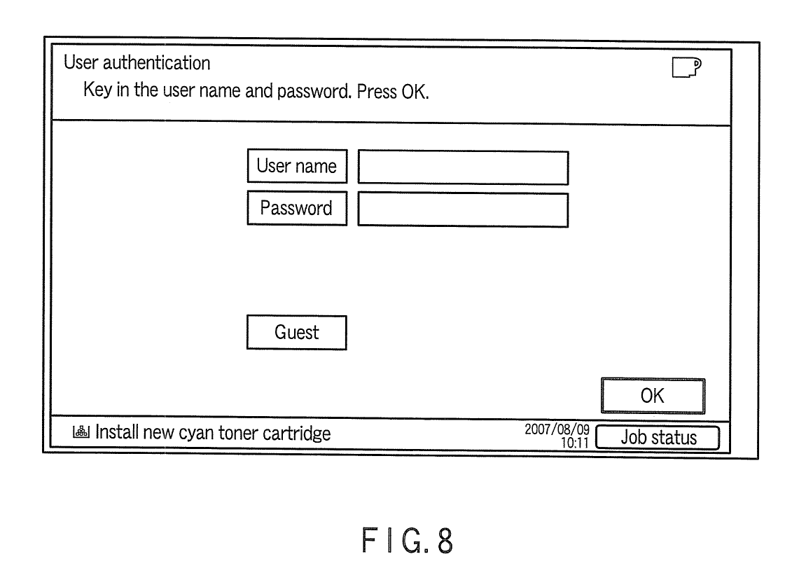

In Act 01, when the user uses the image forming apparatus 2, the user causes the image forming apparatus 2 to display an authentication screen on the control panel 25. In Act 02, the user inputs authentication information from the authentication screen. FIG. 8 is an exemplary view showing a diagram of an authentication screen according to an embodiment. When the user inputs a user name and a password and depresses an OK button, the image forming apparatus 2 transmits the input user name and password to the server 3. As an authentication method, for example, there is an authentication method for authenticating the user using a device such as a method of inputting authentication data using a non-contact IC or the like. Information input for authentication and authenticating means are not specifically designated.

In Act 03, authentication processing is executed in the server 3. In the server 3, the authenticating unit 31 searches through the authentication database 33 on the basis of the transmitted user name and password and executes authentication. The authenticating unit 31 transmits an authentication result of authentication OK or authentication NG to the image forming apparatus 2.

In the case of NO in Act 04, i.e., if the authentication result is NG, in Act 05, the control unit 21 of the image forming apparatus 2 displays indication that the authentication is in error on the control panel 25. The user executes the operation from Act 01 again.

In the case of Yes in Act 04, i.e., if the authentication result is OK, in Act 06, the control unit 21 of the image forming apparatus 2 requests the server 3 to transmit user information. In the server 3, the role managing unit 32 searches through the role management database 34 and extracts roles allocated to the user. The role managing unit 32 transmits a result of the extraction to the image forming apparatus 2.

In Act 07, the control unit 21 of the image forming apparatus 2 sets the roles allocated to the user in a usable state. Specifically, the control unit 21 shifts printing, scanning, facsimile, and the like to the usable state. The control unit 21 displays an operation screen for causing the image forming apparatus 2 to execute jobs for the usable roles on the control panel 25.

In Act 08, the user performs setting for the jobs via the operation screen. For example, the user selects copying as a job and sets a color type (full-color, monochrome, etc.), the number of printed sheets, a sheet size (A4, A3, B5, etc.), a sheet type (plain paper, thick paper, OHP, etc.), and a printing mode (normal, sort, etc.). In Act 09, when the user instructs the image forming apparatus 2 to execute the job set by the user, the control unit 21 of the image forming apparatus 2 transmits setting information of the job set by the user to the server 3 at timing of the start of printing operation. The job setting information also includes information for allowing the image forming apparatus 2 to determine whether the number of printed sheets is decided (explained later).

The server 3 instructs, on the basis of the information transmitted from the image forming apparatus 2, the number of sheets printed in the image forming apparatus 2. The number of printed sheets instructed by the server 3 is referred to as provisional limited number of printed sheets.

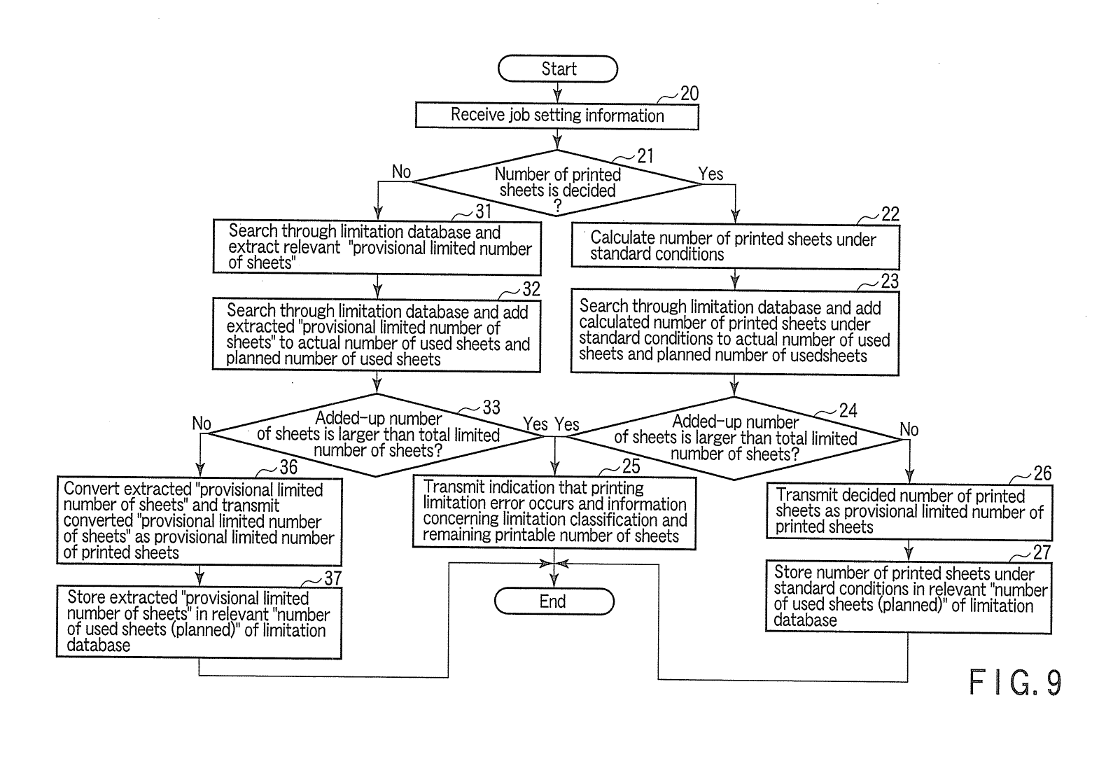

FIG. 9 is an exemplary view showing a flowchart for explaining a processing procedure for calculating a provisional limited number of printed sheets in the server according to an embodiment.

In Act 20, the role managing unit 32 of the server 3 receives job setting information from the image forming apparatus 2. In Act 21, the role managing unit 32 grasps, on the basis of the received information, whether the number of printed sheets is decided at the start of printing operation.

If the printing mode is “sort” and an ADF (Automatic Document Feeder) is used, the printing operation is started after all original documents are read. Therefore, the number of printed sheets at this point is decided as a number of original documents n×a number of printed copies m. On the other hand, if the printing mode is “normal”, since the printing operation is started every time an original document is read via the ADF, the number of printed sheets is undecided.

In the case of Yes in Act 21, i.e., if the number of printed sheets is decided, the role managing unit 32 converts a decided number of printed sheets P into a number of printed sheets S₀ under the standard conditions. For example, in the case of printing in full-color, as indicated by the following Formula (1), a double of the decided number of printed sheets P is calculated as the number of printed sheets S₀ under the standard conditions:

S₀=2×P (1)

In Act 23, the role managing unit 32 retrieves relevant information of the user in the limitation database 35 and calculates a total number of printed sheets T by adding up the number of sheets printed so far and a planned number of printed sheets. The role managing unit 32 calculates a planned cumulative number of sheets C by adding the number of printed sheets S₀ under the standard conditions to the total number of sheets T.

T=Σ{cumulative number of used sheets (actual)+number of used sheets (planned)} (2)

C=T+S₀ (3)

In Act 24, the role managing unit 32 checks whether the planned cumulative number of sheets C is larger than the “total limited number of sheets” in the limitation database 35.

In the case of Yes in Act 24, i.e., if sheets equivalent to the number of sheets larger than the number of sheets admitted by the user are printed when the image forming apparatus 2 performs printing, in Act 25, the role managing unit 32 transmits error information to the image forming apparatus 2. Specifically, the role managing unit 32 transmits, to the image forming apparatus 2, indication that a printing limitation error occurs, items registered in the “limitation classification” and the “limited number of sheets” in the limitation database 35, a reference value of the “limited number of sheets”, and a remaining printable number of sheets. The role managing unit 32 ends the processing for calculating the provisional limited number of printed sheets.

In the case of No in Act 24, i.e., if sheets equivalent to the number of sheets within the number of sheets admitted by the user are printed even if the image forming apparatus 2 performs printing, in Act 26, the role managing unit 32 determines a provisional limited number of printed sheets M as the decided number of printed sheets P. The role managing unit 32 transmits a message indicating that the calculation of the provisional limited number of printed sheets is successful and the provisional limited number of printed sheets M to the image forming apparatus 2.

In Act 27, the role managing unit 32 stores the printed number of sheets S₀ under the standard conditions in the relevant “number of used sheets (planned)” in the limitation database 35. The role managing unit 32 ends the processing for calculating the provisional limited number of printed sheets.

In the case of No in Act 21, i.e., if the number of printed sheets is not decided, in Act 31, the role managing unit 32 searches through the limitation database 35 and extracts the relevant “provisional limited number of sheets”. In Act 32, the role managing unit 32 retrieves relevant information of the user in the limitation database 35 and calculates the total number of sheets T by adding up the number of sheets printed so far and the planned number of printed sheets. The role managing unit 32 calculates the planned cumulative number of sheets C by adding the extracted “provisional limited number of sheets” to the total number of sheets T.

T=Σ{cumulative number of used sheets (actual)+number of used sheets (planned)} (4)

C=T+“provisional limited number of sheets” (5)

In Act 33, the role managing unit 32 checks whether the planned cumulative number of sheets C is larger than the “total limited number of sheets” in the limitation database 35.

In the case of Yes in Act 33, i.e., if sheets equivalent to the number of sheets larger than the number of sheets admitted by the user are printed when the image forming apparatus 2 performs printing, in Act 25, the role managing unit 32 transmits error information to the image forming apparatus 2. Specifically, the role managing unit 32 transmits, to the image forming apparatus 2, indication that a printing limitation error occurs, items registered in the “limitation classification” and the “limited number of sheets” in the limitation database 35, a reference value of the “limited number of sheets”, and a remaining printable number of sheets. The role managing unit 32 ends the processing for calculating the provisional limited number of printed sheets.

In the case of No in Act 33, i.e., if sheets equivalent to the number of sheets within the number of sheets admitted by the user are printed even if the image forming apparatus 2 performs printing, in Act 36, the role managing unit 32 sets the extracted “provisional limited number of sheets” as a value Q. The value Q is the number of printed sheets under the standard conditions. Therefore, the role managing unit 32 converts the value Q into the number of sheets under printing conditions in the image forming apparatus 2 on the basis of job setting information and sets the converted value as the provisional limited number of printed sheets M. The role managing unit 32 transmits a message indicating that the calculation of the provisional limited number of printed sheets is successful and the provisional limited number of printed sheets M to the image forming apparatus 2.

In Act 37, the role managing unit 32 stores the extracted “provisional limited number of sheets” in the relevant “number of used sheets (planned)” in the limitation database 35. The role managing unit 32 ends the processing for calculating the provisional limited number of printed sheets.

In Act 10 in FIG. 7, the control unit 21 of the image forming apparatus 2 acquires processing result information concerning the provisional limited number of printed sheets transmitted from the server 3. In Act 11, the control unit 21 determines whether the calculation of the provisional limited number of printed sheets in the server 3 is successful.

In the case of No in Act 11, i.e., if an error occurs in the calculation of the provisional limited number of printed sheets in the server 3, in Act 12, the control unit 21 displays indication that an error in printing limitation occurs and content of the error on the control panel 25. The control unit 21 returns to Act 07, displays the operation screen, and enables operation input for the user to execute a job again.

The error message displayed on the control panel 25 is, for example, “sheets equivalent to the number of sheets designated cannot be printed due to printing limitation. Please set the number of sheets again.” Examples of the error content displayed on the control panel 25 include content of the “limitation classification”, information concerning the “limited number of sheets”, and the remaining printable number of sheets registered in the limitation database 35. The user can perform job setting with the number of printed sheets changed referring to this displayed content.

In the case of Yes in Act 11, i.e., if the calculation of the provisional limited number of printed sheets in the server 3 is successful, in Act 15, the control unit 21 executes printing with the acquired provisional limited number of sheets set as an upper limit printed number of sheets.

In Act 16, the control unit 21 determines whether the print job set by the user is completed. In the case of No in Act 16, i.e., if the print job is not completed yet, in Act 17, the control unit 21 determines whether a difference between the printed number of sheets and the provisional limited number of printed sheets is equal to or smaller than a predetermined value.

In the case of No in Act 17, the control unit 21 returns to Act 15 and continues the printing. In the case of Yes in Act 17, it is likely that the number of printed sheets soon reaches the provisional limited number of printed sheets and the printing cannot be continued. Therefore, the control unit 21 transmits an actual number of sheets printed so far to the server 3 together with an instruction for requesting an additional provisional limited number of printed sheets.

The server 3 instructs, on the basis of the request for the additional provisional limited number of printed sheets transmitted from the image forming apparatus 2, the additional provisional limited number of printed sheets printed in the image forming apparatus 2.

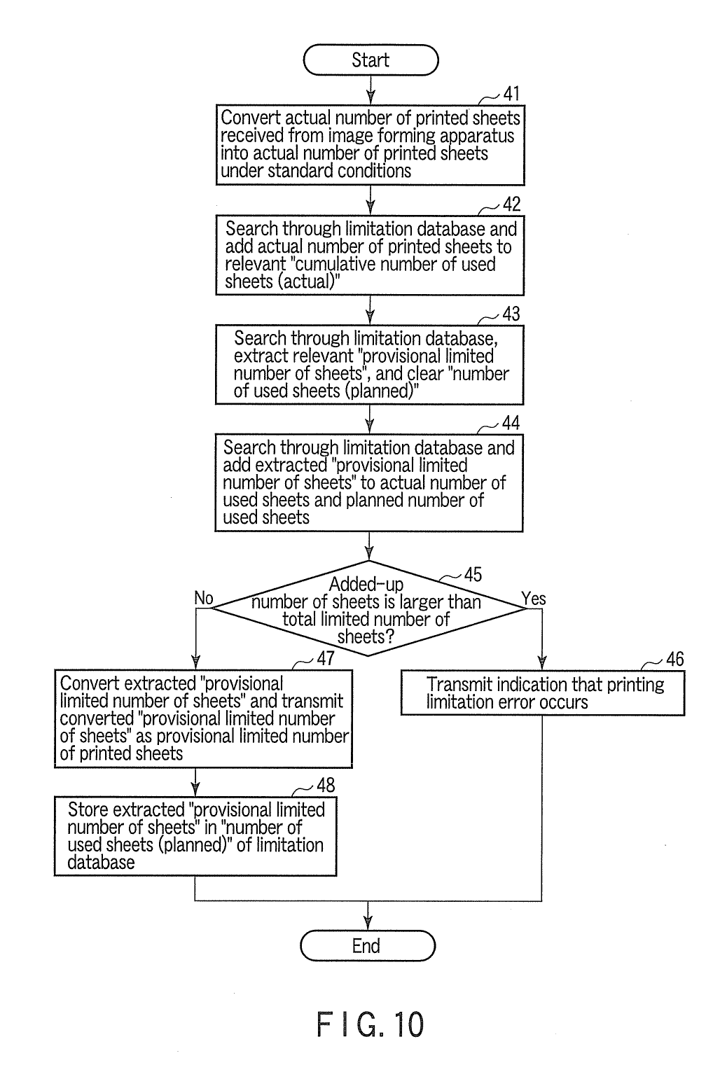

FIG. 10 is an exemplary view showing a flowchart for explaining a processing procedure for calculating an additional provisional limited number of printed sheets in the server according to an embodiment.

In Act 41, the role managing unit 32 converts the actual number of printed sheets received from the image forming apparatus 2 into an actual number of printed sheets under the standard conditions. In Act 42, the role managing unit 32 searches through the limitation database 35 and adds the converted actual number of printed sheets under the standard conditions to the relevant “cumulative number of used sheets (actual)”.

In Act 43, the role managing unit 32 searches through the limitation database 35 and extracts the relevant “provisional limited number of sheets”. The role managing unit 32 clears the “number of used sheets (planned)” to zero. In Act 44, the role managing unit 32 retrieves relevant information of the user in the limitation database 35 and calculates the total number of sheets T by adding up the number of sheets printed so far and the planned number of printed sheets. The role managing unit 32 calculates the planned cumulative number of sheets C by adding the extracted “provisional limited number of sheets” to the total number of sheets T.

T=Σ{cumulative number of used sheets (actual)+number of used sheets (planned)} (6)

C=T+“provisional limited number of sheets” (7)

In Act 45, the role managing unit 32 checks whether the planned cumulative number of sheets C is larger than the “total limited number of sheets” in the limitation database 35.

In the case of Yes in Act 45, i.e., if sheets equivalent to the number of sheets larger than the number of sheets admitted by the user are printed when the image forming apparatus 2 performs printing, in Act 46, the role managing unit 32 transmits error information to the image forming apparatus 2. Specifically, the role managing unit 32 transmits indication that a printing limitation error occurs and the remaining printable number of sheets to the image forming apparatus 2. The role managing unit 32 ends the processing for calculating the additional provisional limited number of printed sheets.

In the case of No in Act 45, i.e., if sheets equivalent to the number of sheets within the number of sheets admitted by the user are printed even if the image forming apparatus 2 performs printing, in Act 47, the role managing unit 32 sets the extracted “provisional limited number of sheets” as the value Q. The value Q is the number of printed sheets under the standard conditions. Therefore, the role managing unit 32 converts the value Q into the number of sheets under printing conditions in the image forming apparatus 2 on the basis of job setting information and sets the converted value as the provisional limited number of printed sheets M. The role managing unit 32 transmits a message indicating that the calculation of the provisional limited number of printed sheets is successful and the provisional limited number of printed sheets M to the image forming apparatus 2.

In Act 48, the role managing unit 32 stores the extracted “provisional limited number of sheets”=Q in the relevant “number of used sheets (planned)” in the limitation database 35. The role managing unit 32 ends the processing for calculating the additional provisional limited number of printed sheets.

In Act 10 in FIG. 7, the control unit 21 of the image forming apparatus 2 acquires the information concerning the additional provisional limited number of printed sheets transmitted from the server 3. In Act 11, the control unit 21 determines whether the calculation of the additional provisional limited number of printed sheets in the server 3 is successful.

In the case of No in Act 11, i.e., if an error occurs in the calculation of the provisional limited number of printed sheets in the server 3, in Act 12, the control unit 21 displays indication that an error in printing limitation occurs and content of the error on the control panel 25. The control unit 21 returns to Act 07 and enables operation input for the user to execute a job again.

The error message displayed on the control panel 25 is, for example, “n sheets are printed so far but the number of sheets designated cannot be printed due to printing limitation. Please set the number of sheets again.” Examples of the error content displayed on the control panel 25 include the remaining printable number of sheets. The user can perform job setting with the number of printed sheets changed referring to this displayed content.

In the case of Yes in Act 11, i.e., if the calculation of the provisional limited number of printed sheets in the server 3 is successful, in Act 15, the control unit 21 executes printing with the number of sheets obtained by adding the acquired provisional limited number of printed sheets to the remaining number of printed sheets set as an upper limit printed number of sheets.

In Act 16, the control unit 21 determines whether the print job set by the user is completed. In the case of No in Act 16, i.e., if the print job is not completed yet, the control unit 21 executes the processing from Act 17. Since the processing is already explained, redundant explanation of the processing is omitted.

In the case of Yes in Act 16, i.e., if the print job is completed, in Act 18, the control unit 21 transmits indication that the printing is completed and the actual number of sheets printed so far to the server 3.

The server 3 ends the printing limitation control between the server 3 and the image forming apparatus 2 on the basis of the printing completion notification transmitted from the image forming apparatus 2.

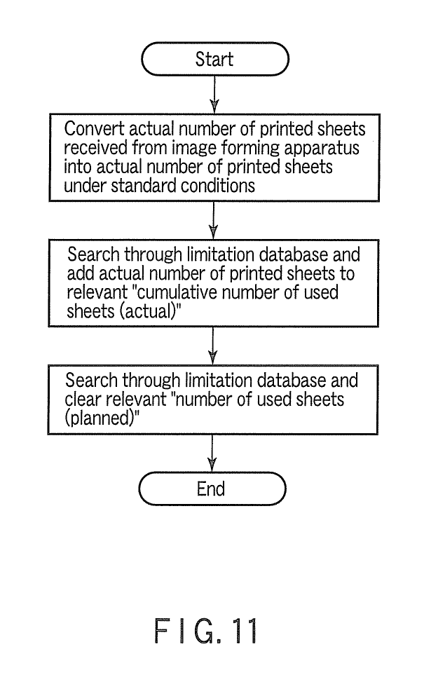

FIG. 11 is an exemplary view showing a flowchart for explaining a processing procedure for ending printing limitation control in the server according to an embodiment.

In Act 51, the role managing unit 32 converts the actual number of printed sheets received from the image forming apparatus 2 into an actual number of printed sheets under the standard conditions. In Act 52, the role managing unit 32 searches through the limitation database 35 and adds the converted actual number of printed sheets under the standard conditions to the relevant “number of used sheets (actual)”. In Act 53, the role managing unit 32 searches through the limitation database 35 and clears the “number of used sheets (planned)” to zero.

In the embodiment described above, the “number of used sheets (planned)” is registered in the limitation database 35 for each of the image forming apparatuses 2, and the “cumulative number of used sheets (planned)” is calculated by adding the “number of used sheets (planned)” of each image forming apparatus 2. However, this does not impose any limiting aspect, and data region “cumulative number of used sheets (planned)” may be integrated in the limitation database 35.

The image forming apparatus and the image forming system according to the above embodiment may be modified as described below.

After a user is authenticated in Act 04 shown in FIG. 7, the image forming apparatus 2 requests that the server 3 provide user information, in Act 06 shown in FIG. 7. The image forming apparatus 2 acquires information on the user from the server 3. The acquired information includes user information (account information, a password, roll information, information on the numbers of sheets), limitation information on the limitation database 35 required for printing processing, and information on the numbers of sheets (the provisional number of sheets, the limited number of sheets, the cumulative number of sheets, or the like).

When executing jobs, the image forming apparatus 2 counts the number of sheets based on job parameters and limits its own print jobs based on the limitation information of the limitation database 35 acquired from the server and on the information on the numbers of sheets (such as the provisional number of sheets, the limited number of sheets, the cumulative number of sheets, or the like). During the execution of jobs, the information required for processing and the information on the actual state of processing are exchanged between the image forming apparatus 2 and the server 3, where necessary. Therefore, the processing takes place without any discrepancy between the image forming apparatus 2 and the server 3.

According to this modification, each image forming apparatus 2 shares information that are managed in a centralized manner, by way of a network. Based on the shared information, each image forming apparatus 2 executes printing while simultaneously controlling its print limiting operation.

The image forming apparatus and the image forming system according to the embodiment explained above realize remarkable effects compared with the related art.

According to this embodiment, it is possible to perform unified user management using plural image forming apparatuses. Therefore, since the user management is unified, even if a management method is changed, it is possible to flexibly cope with the change.

Further, in this embodiment, control concerning printing limitation is executed in the server and the image forming apparatus connected to the server executes image forming operation according to an instruction from the server. Therefore, since a control function concerning the user management is unnecessary in the image forming apparatus, it is possible to realize efficiency of the image forming operation and a reduction in size of the image forming apparatus.

In the embodiment, the server configured to perform the user management is explained as the apparatus different from the image forming apparatus. However, one of the plural image forming apparatuses may be configured as an apparatus having the function of the server.

The functions explained in the embodiment may be configured by using hardware. Also, the functions may be realized by causing, using software, a computer to read a computer program describing the functions. The functions may be configured by selecting the software or the hardware as appropriate.

Further, the functions can also be realized by causing the computer to read a computer program stored in a not-shown recording medium. A recording form of the recording medium in this embodiment may be any form as long as the recording medium is a recording medium that can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus connected to a server apparatus via a communication line, the image forming apparatus comprising:
an authentication requesting unit configured to transmit input authentication information of a user or a department to the server apparatus and request the server apparatus to authenticate the user or the department;
a setting-information acquiring unit configured to acquire, if the user or the department is authenticated by the server apparatus, setting information input concerning a job allocated to the authenticated user or department;
a setting-information transmitting unit configured to transmit the setting information including a type of the job and a number of printed sheets to the server apparatus and request the sever apparatus to permit printing;
a printing unit configured to receive a provisional limited number of printed sheets, which is a number of printed sheets permitted by the server apparatus, from the server apparatus and execute printing;
an addition requesting unit configured to request transmission of a new provisional limited number of printed sheets if a cumulative number of printed sheets is smaller than the number of printed sheets of the setting information even if sheets equivalent to the provisional limited number of printed sheets are printed and if a remaining number of printed sheets for completing printing of the sheets equivalent to the received provisional limited number of printed sheets is within a predetermined number of sheets;
an additional printing unit configured to receive the new provisional limited number of printed sheets from the server apparatus and execute the printing; and
a number-of-printed sheets transmitting unit configured to transmit a number of printed sheets to the server apparatus in a predetermined case.

2. The apparatus according to claim 1, wherein the predetermined case is a case in which the remaining number of printed sheets for completing the printing of the sheets equivalent to the provisional limited number of printed sheets is within the predetermined number of sheets or a case in which the printing ends.

3. The apparatus according to claim 1, further comprising an error output unit configured to output the number of printed sheets of the setting information and a remaining number of printed sheets if the apparatus receives, from the server apparatus, error information including indication that the printing cannot be permitted because of printing limitation and the remaining number of printed sheets permitted to the user or the department.

4. The apparatus according to claim 1, wherein the setting information further includes information for determining, before a job of an input type is executed, whether a number of sheets to be printed in the job is decided.

5. The apparatus according to claim 4, wherein the setting information further includes a color type, a sheet size, and a sheet type.

6. An image forming system comprising:
at least one image forming apparatus; and
a server apparatus connected to the image forming apparatus via a communication line,
the image forming apparatus including:
an authentication requesting unit configured to transmit input authentication information of a user or a department to the server apparatus and request the server apparatus to authenticate the user or the department;
a setting-information acquiring unit configured to acquire, if the user or the department is authenticated by the server apparatus, setting information input concerning a job allocated to the authenticated user or department;
a setting-information transmitting unit configured to transmit the setting information including a type of the job and a number of printed sheets to the server apparatus and request the sever apparatus to permit printing;
a printing unit configured to receive a provisional limited number of printed sheets, which is a number of printed sheets permitted by the server apparatus, from the server apparatus and execute printing;
an addition requesting unit configured to request transmission of a new provisional limited number of printed sheets if a cumulative number of printed sheets is smaller than the number of printed sheets of the setting information even if sheets equivalent to the provisional limited number of printed sheets are printed and if a remaining number of printed sheets for completing printing of the sheets equivalent to the received provisional limited number of printed sheets is within a predetermined number of sheets;
an additional printing unit configured to receive the new provisional limited number of printed sheets from the server apparatus and execute the printing; and
a number-of-printed sheets transmitting unit configured to transmit a number of printed sheets to the server apparatus in a predetermined case, and
the server apparatus including:
an authentication executing unit configured to execute authentication on the basis of the authentication information from the image forming apparatus and transmit a result of the authentication to the image forming apparatus;
a determining unit configured to determine whether the number of printed sheets included in the setting information from the image forming apparatus exceeds a remaining number of printed sheets permitted to the user or the department;
a permitted-number-of-sheets transmitting unit configured to calculate, if the determining unit determines that the number of printed sheets does not exceed the remaining number of printed sheets, a provisional limited number of printed sheets, which is a number of printed sheets permitted to the image forming apparatus, and transmit the provisional limited number of printed sheets to the image forming apparatus; and
an updating unit configured to update, on the basis of the number of printed sheets transmitted from the image forming apparatus, an actual number of sheets printed concerning the user or the department.

7. The system according to claim 6, wherein the predetermined case is a case in which the remaining number of printed sheets for completing the printing of the sheets equivalent to the provisional limited number of printed sheets is within the predetermined number of sheets or a case in which the printing ends.

8. The system according to claim 6, wherein
the setting information further includes a first printing condition including a color type, a sheet size, and a sheet type, and
the server apparatus further includes a number-of-printed sheets converting unit configured to alternately convert the number of printed sheets under the first printing condition included in the setting information and a number of printed sheets under a second printing condition set by the server apparatus as a standard condition.

9. The system according to claim 8, wherein
the setting information further includes information for determining, before a job of an input type is executed, whether a number of sheets to be printed in the job is decided, and
the server apparatus further includes a provisional-limited-number-of-printed-sheets transmitting unit configured to set, if the determining unit determines that the number of printed sheets does not exceed the remaining number of printed sheets and determines on the basis of the setting information that the number of sheets to be printed is decided, the number of printed sheets included in the setting information as the provisional limited number of printed sheets and transmit the number of printed sheets to the image forming apparatus and set, if the determining unit determines on the basis of the setting information that the number of sheets to be printed is not decided, as the provisional limited number of printed sheets, a printed number of sheets under the first printing condition obtained by converting, with the number-of-printed-sheets converting unit, a predetermined number of sheets under the second printing condition set for each the image forming apparatus and transmit the number of printed sheets to the image forming apparatus.

10. The system according to claim 8, wherein
the server apparatus further includes an error-information transmitting unit configured to transmit, if the determining unit determines that the number of printed sheets exceeds the remaining number of printed sheets, to the image forming apparatus, error information including indication that printing cannot be permitted because of printing limitation and a remaining number of printed sheets under the first printing condition obtained by converting, with the number-of-printed-sheets converting unit, a remaining number of printed sheets under the second printing condition permitted to the user or the department, and
the image forming apparatus further includes an error output unit configured to output, if the error information is received from the server apparatus, the number of printed sheets of the setting information and the remaining number of printed sheets included in the error information.

11. An image forming method for an image forming system including at least one image forming apparatus and a server apparatus connected to the image forming apparatus via a communication line, the method comprising:
the image forming apparatus
transmitting input authentication information of a user or a department to the server apparatus and requesting the server apparatus to authenticate the user or the department;
acquiring, if the user or the department is authenticated by the server apparatus, setting information input concerning a job allocated to the authenticated user or department;
transmitting the setting information including a type of the job and a number of printed sheets to the server apparatus and requesting the sever apparatus to permit printing;
receiving a provisional limited number of printed sheets, which is a number of printed sheets permitted by the server apparatus, from the server apparatus and executing printing;
requesting transmission of a new provisional limited number of printed sheets if a cumulative number of printed sheets is smaller than the number of printed sheets of the setting information even if sheets equivalent to the provisional limited number of printed sheets are printed and if a remaining number of printed sheets for completing printing of the sheets equivalent to the received provisional limited number of printed sheets is within a predetermined number of sheets;
receiving the new provisional limited number of printed sheets from the server apparatus and executing the printing; and
transmitting a number of printed sheets to the server apparatus in a predetermined case, and
the server apparatus
executing authentication on the basis of the authentication information from the image forming apparatus and transmitting a result of the authentication to the image forming apparatus;
determining whether the number of printed sheets included in the setting information from the image forming apparatus exceeds a remaining number of printed sheets permitted to the user or the department;
calculating, if it is determined that the number of printed sheets does not exceed the remaining number of printed sheets, the provisional limited number of printed sheets, which is the number of printed sheets permitted to the image forming apparatus, and transmitting the provisional limited number of printed sheets to the image forming apparatus; and
updating, on the basis of the number of printed sheets transmitted from the image forming apparatus, an actual number of sheets printed concerning the user or the department.

12. The method according to claim 11, wherein the predetermined case is a case in which the remaining number of printed sheets for completing the printing of the sheets equivalent to the provisional limited number of printed sheets is within the predetermined number of sheets or a case in which the printing ends.

13. The method according to claim 11, wherein
the setting information further includes a first printing condition including a color type, a sheet size, and a sheet type, and
the method further comprises the server apparatus alternately converting the number of printed sheets under the first printing condition included in the setting information and a number of printed sheets under a second printing condition set by the server apparatus as a standard condition.

14. The method according to claim 13, wherein
the setting information further includes information for determining, before a job of an input type is executed, whether a number of sheets to be printed in the job is decided, and
the method further comprises the server apparatus setting, if it is determined that the number of printed sheets does not exceed the remaining number of printed sheets and determining on the basis of the setting information that the number of sheets to be printed is decided, the number of printed sheets included in the setting information as the provisional limited number of printed sheets and transmitting the number of printed sheets to the image forming apparatus and setting, if it is determined on the basis of the setting information that the number of sheets to be printed is not decided, as the provisional limited number of printed sheets, a printed number of sheets under the first printing condition obtained by converting a predetermined number of sheets under the second printing condition set for each the image forming apparatus and transmitting the number of printed sheets to the image forming apparatus.

15. The method according to claim 13, further comprising:
the server apparatus transmitting, if it is determined that the number of printed sheets exceeds the remaining number of printed sheets, to the image forming apparatus, error information including indication that printing cannot be permitted because of printing limitation and a remaining number of printed sheets under the first printing condition obtained by converting a remaining number of printed sheets under the second printing condition permitted to the user or the department, and
the image forming apparatus outputting, if the error information is received from the server apparatus, the number of printed sheets of the setting information and the remaining number of printed sheets included in the error information.
